(19) United States
(12) Patent Application Publication
(10) Pub. No.: US 2026/0179112 A1
(43) Pub. Date: Jun. 25, 2026

(54) PROACTIVE DISCOVERY AND NOTIFICATIONS FOR SOFTWARE END OF SERVICE LIFE

(71) Applicant: AT&T Intellectual Property I, L.P., Atlanta, GA (US)

(72) Inventors: Jocelyne Nassar, Atlanta, GA (US); Barrett Kreiner, Woodstock, GA (US); Elizabeth S. Veazey, Flower Mound, TX (US); Eric S. Eichholz, Eugene, MO (US); David L. Cane, Alpharetta, GA (US); Yun Wang, Celina, TX (US); Jeremy D. Green, Castle Rock, CO (US); Peter Ikeda, Aromas, CA (US); Lou Topfl, Atlanta, GA (US); Scott K. Burek, Hamburg, NY (US); William Sudbrook, Crystal Lake, IL (US); Kendall Miller, Hoover, AL (US); Balaji Swaminathan, Cumming, GA (US); Scott D. Etheridge, Atlanta, GA (US)

(21) Appl. No.: 19/000,679

(22) Filed: Dec. 23, 2024

(51) Int. Cl. G06Q 30/0203

(52) U.S. Cl. CPC G06Q 30/0203

(57) ABSTRACT

An example method includes obtaining a result of a business application discovery process, where the result lists a plurality of software packages installed on a computing system of an enterprise, identifying a first software package of the plurality of software packages for which an end of service life is scheduled to occur within a defined period of time, identifying a set of business applications of the enterprise that uses the first software package, delivering, for each business application of the set of business applications, a notification to an owner of the each business application alerting the owner to the end of service life for the first software package, wherein the notification includes a hyperlink to a survey about the each business application, collecting responses of the owner to the survey, and generating a dashboard that aggregates the responses with data about other software packages used by the owner.

The present disclosure relates generally to business applications and software and relates more particularly to devices, non-transitory computer-readable media, and methods for proactive discovery and notification of software end of service life.

### BACKGROUND

Enterprise computing systems often utilize various business applications in the form of software packages installed on computing devices such as servers or operating systems (e.g., virtual machines, physical hardware, dedicated devices, cloud systems, or the like). A business application, in this context, may be a group of associated devices and software used to deliver business functionality, or even a single device used for a task-specific purpose (e.g., a desktop computer used for business purposes). A large enterprise may have as many as 100,000 or more servers, and each of these servers may host ten or more software packages that support business applications of the enterprise.

### SUMMARY

Devices, non-transitory computer-readable media, and methods for proactive discovery and notification of software end of service life are disclosed. An example method includes obtaining, from a discovery tool, a result of a business application discovery process, where the result lists a plurality of software packages installed on a computing system of an enterprise, identifying a first software package of the plurality of software packages for which an end of service life is scheduled to occur within a defined period of time, identifying a set of business applications of the enterprise that uses the first software package, delivering, for each business application of the set of business applications, a notification to an owner of the each business application alerting the owner to the end of service life for the first software package, wherein the notification includes a hyperlink to a survey about the each business application, collecting responses of the owner to the survey, and generating based on the responses, a dashboard that aggregates the responses with data about other software packages used by the owner.

In another example, a non-transitory computer-readable medium stores instructions which, when executed by a processing system including at least one processor, cause the processing system to perform operations. The operations include obtaining, from a discovery tool, a result of a business application discovery process, where the result lists a plurality of software packages installed on a computing system of an enterprise, identifying a first software package of the plurality of software packages for which an end of service life is scheduled to occur within a defined period of time, identifying a set of business applications of the enterprise that uses the first software package, delivering, for each business application of the set of business applications, a notification to an owner of the each business application alerting the owner to the end of service life for the first software package, wherein the notification includes a hyperlink to a survey about the each business application, collecting responses of the owner to the survey, and generating based on the responses, a dashboard that aggregates the responses with data about other software packages used by the owner.

In another example, a device includes a processing system including at least one processor and a non-transitory computer-readable medium. The non-transitory computer-readable medium stores instructions which, when executed by the processing system, cause the processing system to perform operations. The operations include obtaining, from a discovery tool, a result of a business application discovery process, where the result lists a plurality of software packages installed on a computing system of an enterprise, identifying a first software package of the plurality of software packages for which an end of service life is scheduled to occur within a defined period of time, identifying a set of business applications of the enterprise that uses the first software package, delivering, for each business application of the set of business applications, a notification to an owner of the each business application alerting the owner to the end of service life for the first software package, wherein the notification includes a hyperlink to a survey about the each business application, collecting responses of the owner to the survey, and generating based on the responses, a dashboard that aggregates the responses with data about other software packages used by the owner.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for proactive discovery and notification of software end of service life may operate;

FIG. 2 illustrates a flowchart of an example method for proactive discovery and notification of software end of service life, in accordance with the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for proactive discovery and notification of software end of service life. As discussed above, enterprise computing systems often utilize various business applications in the form of software packages installed on computing devices such as servers or operating systems (e.g., virtual machines, physical hardware, dedicated devices, cloud systems, or the like). A business application, in this context, may be a group of associated devices and software used to deliver business functionality, or even a single device used for a task-specific purpose (e.g., a desktop computer used for business purposes). A large enterprise may have as many as 100,000 or more servers, and each of these servers may host ten or more software packages that support business applications of the enterprise.

Most software packages have a limited service life; that is, after a time, the vendor who provided a software package may cease to support the software package by providing software updates, security patches, technical support, and the like, which may leave the software package vulnerability to security risks. Alternatively, after a time, the vendor may offer extended support for a fee to limit risk to vulnerabilities; however, if the fee is not paid, no support will be provided. When a software package reaches the end of its service life, the application owner (e.g., an enterprise, or a business unit within an enterprise) must typically upgrade to a new version of the software package or replace the software package with a similar software package from a different vendor.

Many application owners tend to be reactive in this context, especially when the application owners may have hundreds or even thousands of software packages to manage. For instance, many owners may not consider what to do about a software package that is approaching its end of service life (or even realize that the software package is approaching its end of service life) until a notification is received from the vendor, which may occur within a few months (e.g., three months) of the end of service life. This leaves many owners with little time to act in a manner that best serves their interests or to react to vulnerabilities such as zero day vulnerabilities (i.e., security flaws that are unknown to the vendor).

Examples of the present disclosure provide a notification engine and dashboard that discovers software packages running on an enterprise's devices (e.g., servers) which are approaching their end of service life within a defined period of time (e.g., two years) and generates notifications to owners of the software packages instructing the owners to plan for the software packages' end of service life. Examples of the present disclosure enrich existing records in a platform that performs application discovery with collected inventory data for an enterprise, including end of service life dates, standards categories and sub-categories, and mappings of application owners (and their chains of command) to generate records and aggregate notifications. For any software packages whose end of service life falls within the defined period of time, examples of the present disclosure may deliver alerts (e.g., email alerts, text message alerts, or the like) to the owners of those software packages notifying the owners of the approaching ends of service life. The alerts may further present the owners with surveys that collect further information about the use of the software packages from the owners. The owners' answers to these surveys may be used to generate recommendations for planning for the software packages' ends of service life.

The increased lead time between notification and end of service life allows the application owners to gain better awareness of potential vulnerabilities affecting their software packages, as well as the extents of these potential vulnerabilities. This, in turn, will lead to quicker responses to security incidents and potential security breaches, which can result in major cost savings related to the purchase of extended support.

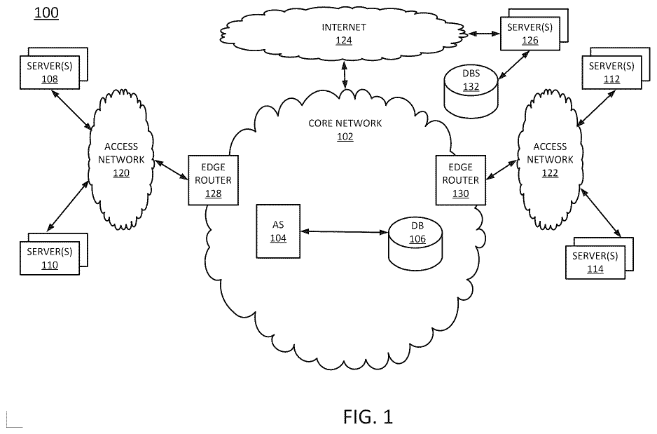

It should be noted that although examples of the present disclosure discuss planning for software packages which are approaching their ends of service life, the same approach could be extended to plan for hardware (e.g., servers and other network devices) which is approaching its end of service life. For instance, hardware for which vendor support (or free vendor support) is scheduled to expire may be identified, and owners of business applications which are supported by the hardware may be notified to facilitate planning for continued support of their business applications. These and other aspects of the present disclosure are discussed in greater detail below in connection with the examples of FIGS. 1-3.

To further aid in understanding the present disclosure, FIG. 1 illustrates an example system 100 in which examples of the present disclosure for proactive discovery and notification of software end of service life may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VOIP) networks, Service over IP (SoIP) networks, the World Wide Web, and the like.

In one example, the system 100 may comprise a core network 102. The core network 102 may be in communication with one or more access networks, such as access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise a Digital Subscriber Line (DSL) network, a public switched telephone network (PSTN) access network, a broadband cable access network, a Local Area Network (LAN), a wireless access network (e.g., an IEEE 802.11/Wi-Fi network and the like), a cellular access network, a 3^{rd} party network, and the like. For example, the operator of the core network 102 may provide a cable television service, an IPTV service, media streaming service, or any other types of communication services to subscribers via access network 120 or access network 122. In one example, the core network 102 may be operated by a telecommunication network service provider. The core network 102 and the access networks 120 and 122 may be operated by different service providers, the same service provider or a combination thereof, or the access networks 120 and 122 may be operated by an entity having a core business that is not related to telecommunications services, e.g., corporate, governmental, or educational institution LANs, and the like.

In one example, the access network 120 may be in communication with servers 108 and 110 at one or more enterprise locations. The access network 120 may transmit and receive communications between the servers 108 and 110, between the servers 108 and 110 and the server(s) 126, the AS 104, other components of the core network 102, devices reachable via the Internet in general, and so forth. Similarly, the access network 122 may be in communication with servers 112 and 114 of one or more enterprise locations. The access network 122 may transmit and receive communications between the servers 112 and 114, between the servers 112 and 114 and the server(s) 126, the AS 104, other components of the core network 102, devices reachable via the Internet in general, and so forth.

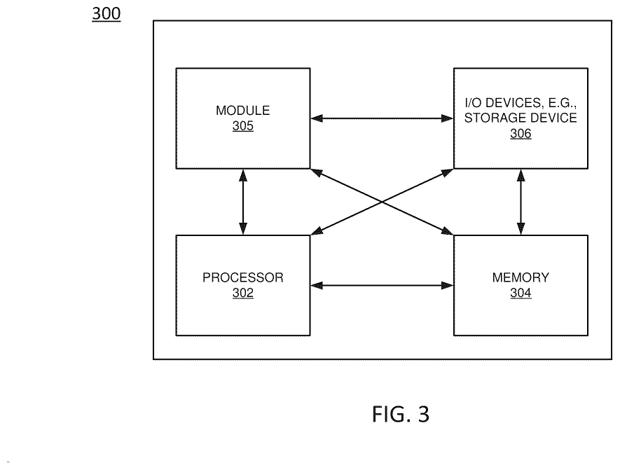

In one example, each enterprise location connected to the system 100 may include a plurality of servers 108, 110, 112, or 114 that support a plurality of business applications. The servers 108, 110, 112, or 114 may each comprise physical hardware servers or operating systems, virtual machines, dedicated devices, cloud systems, or a combination thereof. To this end, any one or more of the servers 108, 110, 112, or 114 may comprise one or more physical devices, e.g., one or more computing systems or servers, such as computing system 300 depicted in FIG. 3, and may be configured as described below. Each of the servers 108, 110, 112, or 114 may have one or more software packages installed thereon and may provide access to resources (e.g., hosts, cores, central processing units, and/or the like) for supporting execution of the software packages to support operations of the respective enterprises.

In one example, one or more remote servers 126 may be accessible to the servers 108, 110, 112, or 114 via the Internet 124 in general. In one example, the server(s) 126 may operate in a manner similar to the servers 108, 110, 112, or 114 or may provide additional resources and/or data to support the business applications. In another example, the server(s) 126 may operate in a manner similar to the AS 104, which is described in further detail below. In one example, DBs 132 may be accessible by the server(s) 126 and/or by the AS 104.

In accordance with the present disclosure, the AS 104 and DB 106 may be configured to provide one or more operations or functions in connection with examples of the present disclosure for proactive discovery and notification of software end of service life, as described herein. For instance, the AS 104 and DB 106 may support discovery tools that interact with servers 108, 110, 112, and 114 to identify software packages installed on the servers 108, 110, 112, and 114. The AS 104 may generate a list of software packages discovered through this process, where each software package may be cross-referenced against a technology catalog, which may be stored by the DB 106.

The DB 106 may store a separate technology catalog for each enterprise (e.g., for each set of servers 108, 110, 112, or 114). Each technology catalog may include a plurality of entries. Each entry in the technology catalog may correspond to a software package and may additionally list a plurality of attributes for the corresponding software package. These attributes may include vendor-specified attributes, such as: date of first release, date on which vendor support (or standard/free vendor support) will no longer be available, common vulnerabilities and exposures (CVEs), and the like. An enterprise may also assign one or more internal or proprietary attributes to a software package, such as: business applications of the enterprise that use the software package, whether the enterprise prefers to avoid or encourage use of the software package, plans to discontinue use of, replace, or upgrade the software package, and the like.

For each enterprise, the AS 104 may attempt to identify, based on information in the technology catalog, software packages for which the end of service life is scheduled to occur within a defined period of time (e.g., two years). The AS 104 may further identify business applications of the enterprise that use the software packages whose end of service life is scheduled to occur within the defined period of time. The AS 104 may deliver notifications to owners of the business applications that alert the owners to the approaching ends of service life and ask the owners to respond to surveys to assist in planning for the ends of service life. The owners' responses to the surveys may be aggregated for view by an administrator of the enterprise's computing system and/or review by the owners.

To this end, the AS 104 may comprise one or more physical devices, e.g., one or more computing systems or servers, such as computing system 300 depicted in FIG. 3, and may be configured as described below. As discussed above, the AS 104 may have access to at least one database (DB) 106, where the DB 106 may store technology catalogs for different enterprises associated with the servers 108, 110, 112, and 114. The DB 106 may also store survey responses from owners of business applications as described above.

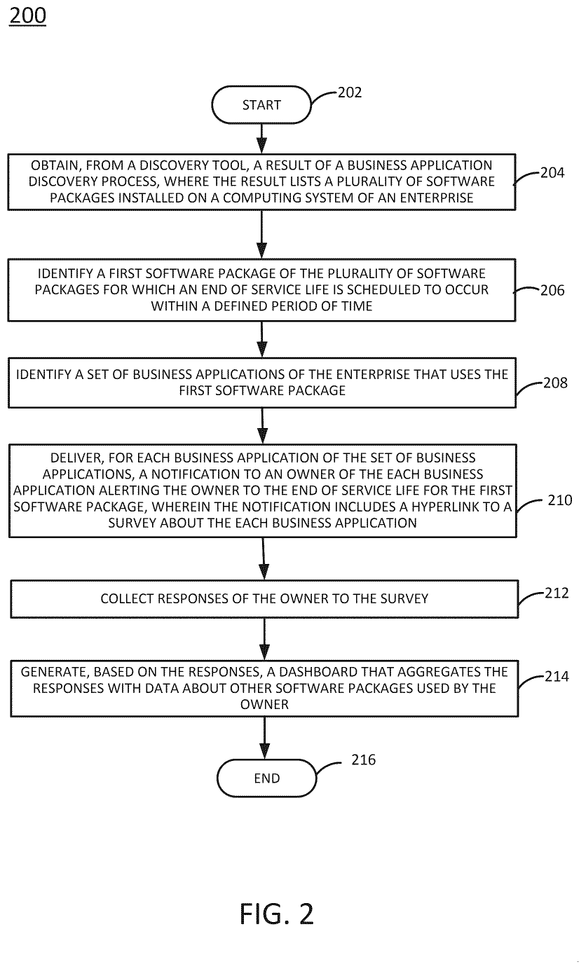

In one example, DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for proactive discovery and notification of software end of service life, as described herein. One example method for proactive discovery and notification of software end of service life is described in greater detail below in connection with FIG. 2.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, media streaming server, a content distribution network (CDN) and the like. For example, portions of the core network 102, access networks 120 and 122, and/or Internet 124 may comprise a content distribution network (CDN) having ingest servers, edge servers, and the like. Similarly, although only two access networks 120 and 122 are shown, in other examples, the access networks 120 and 122 may comprise a plurality of different access networks that may interface with the core network 102 independently or in a chained manner. For example, servers 108-114 may communicate with the core network 102 via different access networks. Thus, these and other modifications are all contemplated within the scope of the present disclosure.

FIG. 2 illustrates a flowchart of an example method 200 for proactive discovery and notification of software end of service life, in accordance with the present disclosure. In one example, steps, functions and/or operations of the method 200 may be performed by a device as illustrated in FIG. 1, e.g., AS 104 or any one or more components thereof. In another example, the steps, functions, or operations of method 200 may be performed by a computing device or system 300, and/or a processing system 302 as described in connection with FIG. 3 below. For instance, the computing device 300 may represent at least a portion of the AS 104 in accordance with the present disclosure. For illustrative purposes, the method 200 is described in greater detail below in connection with an example performed by a processing system, such as processor or processing system 302.

The method 200 begins in step 202 and proceeds to step 204. In step 204, the processing system may obtain, from a discovery tool, a result of a business application discovery process, where the result lists a plurality of software packages installed on a computing system of an enterprise.

Various tools exist to examine an enterprise computing system and perform an inventory of the software packages installed on the computing system. The process of performing this inventory may also be called discovery. The result of discovery is, for a given computing system, a list of software titles (which may be expressed as tuples of vendor, product name, and version or vendor, product name, version, and edition) installed on the computing system.

In step 206, the processing system may identify a first software package of the plurality of software packages for which an end of service life is scheduled to occur within a defined period of time.

In one example, the first software package may be identified by correlating the plurality of software packages with a technology catalog for the enterprise. Each entry in the technology catalog may correspond to a software package and may additionally list a plurality of attributes for the corresponding software package. These attributes may include vendor-specified attributes, such as: date of first release, date on which vendor support (or free/standard vendor support) will no longer be available, common vulnerabilities and exposures (CVEs), and the like. A given enterprise may also assign one or more internal or proprietary attributes to a software package, such as: what business applications use the software package, whether the enterprise prefers to avoid or encourage use of the software package, plans to discontinue use of, replace, or upgrade the software package, and the like.

In one example, the end of service life date may be a date beyond which a vendor of the first software package will cease to support the software package by providing software updates, security patches, technical support, and the like, which may leave the software package vulnerable to security risks. In one example, the defined period of time may be a configurable period of time that is selected by an administrator of the computing system. For instance, the administrator may configure the defined period of time to be a period of time that provides sufficient time for the enterprise to plan around the end of service life. In one example, the defined period of time may be two years; however, in other examples, the defined period of time may be shorter than or longer than two years.

In step 208, the processing system may identify a set of business applications of the enterprise that uses the first software package.

In one example, there may be many different business applications running on the computing system that utilize the same software package. Each of these different business applications may be affected if support for the software package expires. Moreover, the different business applications may be associated with different business units and users within the enterprise, and each business unit or user may plan in a different way for the end of service life of the software package.

In step 210, the processing system may deliver, for each business application of the set of business applications, a notification to an owner of each business application alerting the owner to the end of service life for the first software package, wherein the notification includes a hyperlink to a survey about each business application.

In one example, the owner may be identified from data recorded in the technology catalog, as discussed above. In one example, the notification may comprise a text-based notification, such as an email or a text (e.g., short messaging service) message. The notification may identify the first software package and the each business application that uses the first software package. The notification may further identify the end of service life date for the first software package (e.g., the last date on which the vendor will offer support for the first software package) and/or the amount of time (e.g., days) remaining until the end of service life date. In one example, the notification may additionally indicate whether extended support is offered by the vendor beyond the end of standard support. For instance, the vendor may cease to provide standard support for the first software package beyond a specified date, but may offer extended support beyond the specified date for a fee.

The notification may also include a hyperlink to a survey about each business application and may request that the owner complete the survey to facilitate planning by the enterprise for the end of service life for the first software package. In one example, the notification may set a deadline for the owner to complete the survey. The deadline may be earlier than the end of service life date for the first software package. In one example, the processing system may send follow-up notifications periodically until the owner completes the survey. For instance, if the owner has not completed the survey within x days of an initial notification being delivered, then the processing system may send a first follow-up notification. If the owner still has not completed the survey within x days of the first follow-up notification being delivered, then the processing system may deliver a second follow-up notification, and so on until the owner completes the survey. Escalations may be planned after a threshold number of reminders.

In step 212, the processing system may collect responses of the owner to the survey.

In one example, the responses may be collected via a graphical user interface (GUI) that is presented to the owner when the owner launches the hyperlink for the survey. For instance, launching the hyperlink may cause the processing system to present the GUI to the owner, where the GUI poses a series of questions relating to the end of service life for the first software application to the owner. The owner may respond to the plurality of questions by selecting a response from a list of predefined responses, by entering free-form text into a field, or in another manner.

As an example, the survey may include a question asking what the owner's preferred option for addressing the end of service life is, where the preferred option may be selected from a list of options including transform/replace the first software package, upgrade to a newer version of the first software package, remove/retire the first software package, or purchase extended support for the first software package (if offered by the vendor).

Other questions the survey may ask are whether the owner is the appropriate person to complete the survey, whether the owner is currently using the business application(s) that use the software, a target date on which the owner would like the preferred option for addressing the end of service life to be implemented, preferred software with which to replace the software package (if specific options have been identified by the enterprise), and/or other questions. For instance, if the owner indicates that he or she wishes to upgrade the first software package, the survey may present a list of possible software packages that may be selected to which to upgrade. The list of possible software packages may be preselected by an administrator of the computing system to ensure that any selected upgrades are approved for use by the enterprise.

In step 214, the processing system may generate, based on the responses, a dashboard that aggregates the responses with data about other software packages used by the owner.

In one example, a dashboard may present various data items related to end of service life for software packages that are used by business applications associated with an owner. For instance, the dashboard may track any outstanding surveys for which the owner still owes responses, any surveys for which the owner has already provided responses (e.g., if the owner wishes to review and/or modify their responses), end of service life dates for any software packages used by business applications associated with the owner (even if the end of service life dates occur outside of the predefined period of time/no surveys are due for the software packages yet), any servers associated with the owner which may be impacted by software packages reaching their ends of service life, any business applications associated with the owner which may be impacted by software packages reaching their ends of service life, and/or other data relating to the software packages.

In some examples, some of the data presented by the dashboard may be presented in a graphical form. For instance, a bar chart may be used to illustrate the number of servers and/or number of business applications that may be impacted, per year, by software packages reaching their ends of service life. Bar charts could also be used to show the number of software packages associated with each vendor which are scheduled to reach their ends of service life, per year.

In a further example, the dashboard may present an option for the owner of a business application to make a single decision that satisfies surveys for multiple software packages simultaneously. For instance, a business application may use multiple software packages, and at least some of these software packages may be approaching their ends of service life. If the business application is no longer in use (or is scheduled to be no longer in use after a certain date), then the owner may not need to ensure continued support for any of the software packages used by the business application.

In this case, the owner may navigate to an area of the dashboard that lists, for the business application, all of the software packages used by the business application. This area of the dashboard may display other information related to the business application as well, including devices of which the business application and/or the multiple software packages are running. This area of the dashboard may also allow the owner to make a decision for the business application that is carried through to all of the software packages of the multiple software packages. For instance, if the business application is no longer going to be in use, the owner may select an option that indicates that all software packages of the multiple software packages should be removed or retired.

A similar mechanism may be used to indicate upgrades or purchases of extended support for the multiple software packages. This mechanism may save time for the owner by allowing the owner to make a global decision for all software packages used by a business application, rather than assessing each software package one-by-one.

In step 216, the method 200 may end.

Thus, examples of the present disclosure may increase the lead time provided to business application owners to plan for software end of service life. This increased lead time allows the business application owners to gain better awareness of potential vulnerabilities affecting their software packages, as well as the extents of these potential vulnerabilities. This, in turn, will lead to quicker responses to security incidents and potential security breaches, and can also result in major cost savings related to the purchase of extended support.

It should be noted that although the method 200 discusses planning for software packages which are approaching their ends of service life, the same approach could be extended to plan for hardware (e.g., servers and other network devices) which is approaching its end of service life. For instance, hardware for which vendor support (or free vendor support) is scheduled to expire may be identified, and owners of business applications which are supported by the hardware may be notified to facilitate planning for continued support of their business applications.

It should be noted that the method 200 may be expanded to include additional steps or may be modified to include additional operations, parameters, or scores with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for proactive discovery and notification of software end of service life may operate, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for proactive discovery and notification of software end of service life may operate (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for proactive discovery and notification of software end of service life may operate (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
obtaining, by a processing system including at least one processor from a discovery tool, a result of a business application discovery process, where the result lists a plurality of software packages installed on a computing system of an enterprise;
identifying, by the processing system, a first software package of the plurality of software packages for which an end of service life is scheduled to occur within a defined period of time;
identifying, by the processing system, a set of business applications of the enterprise that uses the first software package;
delivering, by the processing system for each business application of the set of business applications, a notification to an owner of the each business application alerting the owner to the end of service life for the first software package, wherein the notification includes a hyperlink to a survey about the each business application;
collecting, by the processing system, responses of the owner to the survey; and
generating, by the processing system based on the responses, a dashboard that aggregates the responses with data about other software packages used by the owner.

2. The method of claim 1, wherein the set of business applications is identified by correlating the plurality of software packages with a technology catalog for the enterprise.

3. The method of claim 1, wherein the end of service life is identified by correlating the first software package with an entry in a technology catalog for the enterprise.

4. The method of claim 1, wherein the defined period of time is a configurable period of time that is selected by an administrator of the computing system.

5. The method of claim 1, wherein the notification comprises a text-based notification.

6. The method of claim 1, wherein the notification sets a deadline for the owner to complete the survey, and wherein the deadline is earlier than the end of service life date for the first software package.

7. The method of claim 1, wherein follow-up notifications are delivered to the owner periodically until the responses are collected.

8. The method of claim 7, wherein an escalation is implemented when the responses have not been collected after a threshold number of the follow-up notifications.

9. The method of claim 1, wherein launching the hyperlink causes the processing system to present a graphical user interface to the owner, and wherein the graphical user interface poses a plurality of questions relating to the end of service life for the first software application to the owner.

10. The method of claim 9, wherein the plurality of questions includes a question asking a preferred option of the owner for addressing the end of service life.

11. The method of claim 10, wherein the preferred option is selected from a predefined list that includes at least one of: replace the first software package, upgrade to a newer version of the first software package, remove the first software package, or purchase an extended support for the first software package.

12. The method of claim 1, wherein the dashboard tracks at least one of: any outstanding surveys for which the owner still owes responses, any surveys for which the owner has already provided responses, or end of service life dates for any software packages of the plurality of software packages used by business applications associated with the owner.

13. The method of claim 1, wherein the responses and the data about the other software packages used by the owner are aggregated for presentation.

14. The method of claim 1, wherein the dashboard includes a mechanism by which the owner is capable of making a single decision for the each business application that is carried through to all software packages of the plurality of software packages that are used by the each business application, including the first software package.

15. The method of claim 14, wherein when the single decision comprises a decision to discontinue use of the each business application, the mechanism indicates that every software package of the all software packages should be retired for the each business application.

16. A non-transitory computer-readable medium storing instructions which, when executed by a processing system including at least one processor, cause the processing system to perform operations, the operations comprising:
obtaining, from a discovery tool, a result of a business application discovery process, where the result lists a plurality of software packages installed on a computing system of an enterprise;
identifying a first software package of the plurality of software packages for which an end of service life is scheduled to occur within a defined period of time;
identifying a set of business applications of the enterprise that uses the first software package;
delivering, for each business application of the set of business applications, a notification to an owner of the each business application alerting the owner to the end of service life for the first software package, wherein the notification includes a hyperlink to a survey about the each business application;
collecting responses of the owner to the survey; and
generating based on the responses, a dashboard that aggregates the responses with data about other software packages used by the owner.

17. The non-transitory computer-readable medium of claim 16, wherein launching the hyperlink causes the processing system to present a graphical user interface to the owner, and wherein the graphical user interface poses a plurality of questions relating to the end of service life for the first software application to the owner.

18. The non-transitory computer-readable medium of claim 16, wherein the dashboard includes a mechanism by which the owner is capable of making a single decision for the each business application that is carried through to all software packages of the plurality of software packages that are used by the each business application, including the first software package.

19. The non-transitory computer-readable medium of claim 18, wherein when the single decision comprises a decision to discontinue use of the each business application, the mechanism indicates that every software package of the all software packages should be retired for the each business application.

20. A device comprising:
a processing system including at least one processor; and
a non-transitory computer-readable medium storing instructions which, when executed by the processing system, cause the processing system to perform operations, the operations comprising:
obtaining, from a discovery tool, a result of a business application discovery process, where the result lists a plurality of software packages installed on a computing system of an enterprise;
identifying a first software package of the plurality of software packages for which an end of service life is scheduled to occur within a defined period of time;
identifying a set of business applications of the enterprise that uses the first software package;
delivering, for each business application of the set of business applications, a notification to an owner of the each business application alerting the owner to the end of service life for the first software package, wherein the notification includes a hyperlink to a survey about the each business application;
collecting responses of the owner to the survey; and
generating based on the responses, a dashboard that aggregates the responses with data about other software packages used by the owner.
